(19) United States
(12) Patent Application Publication
(10) Pub. No.: US 2002/0127992 A1
(43) Pub. Date: Sep. 12, 2002

(54) Wideband local oscillator architecture

(76) Inventor: Bert L. Fransis, San Diego, CA (US)

Correspondence Address: CENTRAL COAST PATENT AGENCY, PO BOX 187, AROMAS, CA, 95004, US

(21) Appl. No.: 09/803,496

(22) Filed: Mar. 8, 2001

(51) Int. Cl. H04B 1/26

(52) U.S. Cl. 455/315; 455/318; 455/313

(57) ABSTRACT

A conversion integrated circuit (IC) for RF signals has a first interface for transmitting or receiving a first number of distinct RF frequency bands in a broadband spectrum, a plurality of circuit elements coupled to the first interface, one for each of the frequency bands, for up-conversion or down-conversion of the frequency bands to and from an intermediate frequency (IF), a second interface coupled to said circuit elements for receiving and transmitting at the intermediate frequency (IF), and a second number of on-chip voltage-controlled oscillators (VCOs) coupled to the circuit elements for generating local-oscillator (LO) signals to the circuit elements for conversion between the IF frequency and the receive or transmit frequency for each band. The IC is characterized in that the second number is smaller than the first number.

### FIELD OF THE INVENTION

The present invention is in the area of radio signal transmission and reception, and has particular application in the processing of radio signals in wide-band applications.

### BACKGROUND OF THE INVENTION

A variety of devices of current technology exist for processing of information-bearing signals such as radio frequency (RF) signals,, and different types of devices are designed to be used with specific frequency bands of varying breadth. The extent of the frequency range from which to select is thereby limited for the user of such devices. However, recent advances in the technology pertaining to telecommunications have resulted in advanced systems capable of receiving and transmitting over a very wide range of bandwidth and frequency. One example of such technology is broadband communication, wherein the overall bandwidth within which signals may be received and transmitted can be very large. A new and fast-growing market utilizing such technology is driven by the demand for high-speed wireless Internet access, for example, provided at different frequencies by Internet service providers. Users receiving signals from such a provider, a satellite Internet service provider, for example, must be able to receive signal frequencies of at least between 900 MHz to 2.15 GHz. In other broadband applications the frequency range can be even greater.

When processing the received signals in a broadband communication system, the modulated signals are processed in digital demodulation blocks, and must be presented to the demodulation circuitry at a fixed intermediate frequency (IF) much lower than that of the incoming signals, due to the limited frequency range capability of conventional demodulation components available. The method of changing the frequency of the incoming signals in such a system is achieved by adding them to local oscillator (LO) signals generated within the receiver by at least one voltage controlled oscillator (VCO), producing fluctuations or beats of the frequency equal to the difference between the two signals. The LO signals generated by the VCO are presented to mixers that down-convert the received signals to the IF, and therefore require a similarly wide frequency range to that of the incoming signals. The receiver then subjects the lower-frequency wave to amplification and subsequent demodulation.

It has been the object of attention in this field of technology to enable the processing of signals from the highest tuning bandwidth possible while maintaining the lowest possible level of phase noise, because a smaller tuning bandwidth is the trade-off for improving the phase noise level in conventional systems. In current art, a traditional method for increasing the frequency tuning range of a VCO while maintaining acceptable phase noise is by utilizing off-chip circuitry comprising high-quality inductors and tuning varactors that have a very high tuning range, and are designed to operate with a high supply voltage of typically 30 volts. This solution, however, has provided unsatisfactory results due to the increased cost of the additional external components needed.

In order to obtain a low-cost and low-complexity solution, manufacturers have integrated the functions of the above-described components into smaller integrated chip devices, for processing of signals within the frequency range that has been split into smaller frequency bands. Although a wide tuning range can be achieved by integrating VCO functions by this method, the result is still unsatisfactory due to the limited frequency tuning range and voltage capacitance of on-chip varactors currently available. In many cases, depending on the phase noise requirements, the frequency range of the VCO can be severely limited, thereby requiring a large number of VCOs to achieve the desired tuning range with acceptable phase noise. A large area on an integrated circuit is occupied by such a large number of components, thereby limiting the compactness of the design of the host device, and also increasing the cost and complexity of the design.

Some transmit and receive systems, such as those used for conventional broadband fixed-wireless access applications, for instance, are designed for operation using several possible specific ranges of signal frequencies, widespread between frequencies ranging from perhaps 2 GHz to 6 GHz. Each separate range of signal frequencies exceeds the tuning range capability of any single integrated on-chip VCO currently available, therefore a separate VCO is usually required for each separate tuning range. It would be preferable, in order to achieve a most compact design, to integrate the functions of the multiple VCOs that would be required, onto a single integrated chip device. However, for the reasons previously stated, the design of such a single device is complex, silicon-area intensive, and expensive utilizing current technology, and thereby limits the number of VCOs that can be integrated into such a chip.

What is clearly needed is an improved method and apparatus for frequency conversion allowing transmit and receive of signals anywhere within the broad range of frequencies used in broadband communication applications. Such a system should reduce the number of limited-frequency voltage controlled oscillators needed to generate the required local oscillator signals to cover the wide range of frequency bands to be served. Such a system might utilize a smart local oscillator architecture that, using available on-chip VCOs with a limited frequency tuning range, to provide a simpler, lower-cost solution for conversion of such signals, and has a tuning range covering the entire broadband frequency spectrum while achieving the desired circuitry phase noise level.

### SUMMARY OF THE INVENTION

In a preferred embodiment of the present invention a conversion integrated circuit (IC) for RF signals is provided, comprising a first interface for transmitting or receiving a first number of distinct RF frequency bands in a broadband spectrum, a plurality of circuit elements coupled to the first interface, one for each of the frequency bands, for up-conversion or down-conversion of the frequency bands to and from an intermediate frequency (IF), a second interface coupled to said circuit elements for receiving and transmitting at the intermediate frequency (IF), and a second number of on-chip voltage-controlled oscillators (VCOs) coupled to the circuit elements for generating local-oscillator (LO) signals to the circuit elements for conversion between the IF frequency and the receive or transmit frequency for each band. The IC is characterized in that the second number is smaller than the first number.

In some embodiments one of the on-chip VCOs, through alternative sideband selection, provides the LO frequency for two or more of the RF frequency bands in the broadband spectrum. Also in some embodiments there is frequency doubling circuitry coupled to one of the VCOs, such that the coupled one of the VCOs provides a different frequency to each of two of the sideband selection circuit elements. In still other embodiments there is frequency doubling circuitry coupled to one of the VCOs, such that the VCO, through frequency doubling and/or redoubling, and through alternative sideband selection, the IC provides the LO frequency for up-conversion or down-conversion of three or more of the RF frequency bands in the broadband spectrum.

In some cases the IC dedicated to down-conversion of the RF frequency bands. In others the IC is dedicated to up-conversion of the RF frequency bands. In still others the IC has circuit elements for both up-conversion and down-conversion.

In another aspect of the invention a broadband receiving/transmitting system is provided, comprising an antenna for receiving or transmitting RF signals in a broadband spectrum including a first number of signal bands, a conversion integrated circuit (IC) coupled to the first number of signal bands by a first interface of the IC, and modulation circuitry coupled to the IC by a second interface of the IC for receiving or transmitting each of the bands at a common intermediate frequency (IF). The system is characterized in that the conversion IC comprises a plurality of circuit elements coupled to the first interface, one for each of the frequency bands, for up-conversion or down-conversion of the frequency bands to and from an intermediate frequency (IF), and a second number of on-chip voltage-controlled oscillators (VCOs) coupled to the circuit elements for generating local-oscillator (LO) signals to the circuit elements for conversion between the IF frequency and the receive or transmit frequency for each band, the second number less than the first number.

In some embodiments one of the on-chip VCOs, through alternative sideband selection, provides the LO frequency for two or more of the RF frequency bands in the broadband spectrum. In other embodiments there is frequency doubling circuitry coupled to one of the VCOs, such that the VCO provides a different frequency to each of two of the sideband selection circuit elements. In still other embodiments there is frequency doubling circuitry coupled to one of the VCOs, such that the VCO, through frequency doubling and/or redoubling, and through alternative sideband selection, provides the LO frequency for up-conversion or down-conversion for three or more of the RF frequency bands.

In some cases the system is dedicated to down-conversion of the RF frequency bands. In others the system is dedicated to up-conversion of the RF frequency bands. In still others there are circuit elements for both up-conversion and down-conversion.

In yet another aspect of the invention a method for providing local oscillator (LO) signals to a first number of sideband-selection circuit elements in up-conversion or down-conversion circuitry, for a broadband spectrum including the first number of frequency bands is provided, comprising the steps of (a) providing a second number of on-chip voltage-controlled oscillators (VCOs), the second number fewer than the first number; and (b) serving all of the circuit elements with appropriate LO frequencies by one or both of alternative sideband selection and frequency doubling techniques.

In some embodiments, in step (b), one of the on-chip VCOs, through alternative sideband selection, provides the LO frequency for two or more of the RF frequency bands in the broadband spectrum. In others, frequency doubling circuitry coupled to one of the VCOs provides a different frequency to each of two of the sideband selection circuit elements, the provided VCO frequency being doubled for one of the circuit elements, and doubled again for another. In still other embodiments frequency doubling circuitry is coupled to one of the VCOs, such that the VCO, through frequency doubling and/or redoubling, and through alternative sideband selection, provides the LO frequency for up-conversion or down-conversion to three or more of the RF frequency bands.

In some cases the method is dedicated to down-conversion of the RF frequency bands. In other cases the method is dedicated to up-conversion of the RF frequency bands. In still other cases the IC is enabled for both up-conversion and down-conversion.

In embodiments of the present invention, taught in enabling detail herein, for the first time a conversion circuit is provided for up- and down-conversion of bands in a broadband frequency spectrum, wherein all VCOs for LOs are provided on-chip, and the number of VCOs is fewer than the number of bands to be served in the spectrum.

### BRIEF DESCRIPTION OF THE DRAWING FIGURES

FIG. 1 illustrates a smart local oscillator architecture for broadband radio frequency conversion according to an embodiment of the present invention.

FIG. 2a illustrates lower sideband selection in a mixer circuit used for conversion of signals according to an embodiment of the present invention.

FIG. 2b illustrates upper sideband selection in a mixer circuit used for conversion of signals according to an embodiment of the present invention.

### DESCRIPTION OF THE PREFERRED EMBODIMENTS

Broadband Internet access has recently begun to gain a share in the Internet consumer market, mostly in the form of cable modems, though availability for such service has so far been extremely limited. Satellite and wireless Internet services offering high-speed Internet access have also become available and are quickly gaining popularity due to the increased mobility and productivity afforded to users of such systems. Broadband fixed-wireless Internet access is one such service, and is a specific application where the present invention is used.

Many attempts have been made to find a low-cost solution for synthesizing signals in a broadband wireless Internet access system that increases frequency tuning range while maintaining phase noise requirements, including off-chip systems and, more recently, on-chip VCO function integration as mentioned earlier. However, by integrating VCO functions in this manner much tuning range and voltage capacitance is lost for each on-chip varactor, and there is a trade-off between tuning or frequency range and phase noise of the VCO. The signal frequencies that need to be processed by such a system are split into separate smaller bands, each band having a frequency range that is covered by the tuning range of each separate VCO circuit. The technology pertaining to broadband fixed wireless Internet access has been allocated a very wide section of the radio frequency band spectrum. The transmit and receive systems in such technology must have the ability to synthesize signals that are very widespread between frequencies ranging from 2 GHz to 6 GHz. The present invention describes a method for synthesizing signals from such a broad range of frequencies, while minimizing the number of voltage controlled oscillators and circuitry needed to generate the required local oscillator signals.

It is assumed that in order to achieve the phase noise requirements as explained earlier, the tuning range for currently available on-chip varactors, regardless of the application in which they are used, is limited to a variation range of 16% of the overall frequency range. However, if the VCO scheme is implemented in another technology and the phase noise requirements cannot be met due to the limited tuning range of the VCO, the frequency band of 16% can be split up into smaller bands, or sidebands, with each VCO covering an equal amount of the needed frequency range. In the specific broadband fixed wireless Internet access application where the present invention is used, the signal frequencies that are to be processed by the transmit and receive systems can vary anywhere from 2 GHz to 6 GHz as mentioned, and are likewise split into separate frequency bands due to the limited tuning range of each separate VCO.

In an embodiment of the present invention an empirical determination has been made of whether a number of VCOs fewer than the number of the frequency bands to be served is a workable option that provides the necessary tuning range. It has occurred to the inventor that by using frequency multiplication techniques coupled with upper and lower sideband principles, it may not be necessary to provide a separate single local oscillator signal to cover each frequency band, thereby reducing the number of separate VCOs required to cover the entire frequency range. The cost and complexity in design of such a silicon device used to provide the local signals is greatly reduced due to reduction in the number of VCOs that must be integrated into the chip. A specific example of such a smart (and unique) local oscillator architecture is provided below, utilizing only two on-chip VCOs to provide the local oscillator signals with a wide frequency range sufficient to cover that of the several separate frequency bands to be served. The skilled artisan will recognize that there will be many variations within the spirit and scope of the invention.

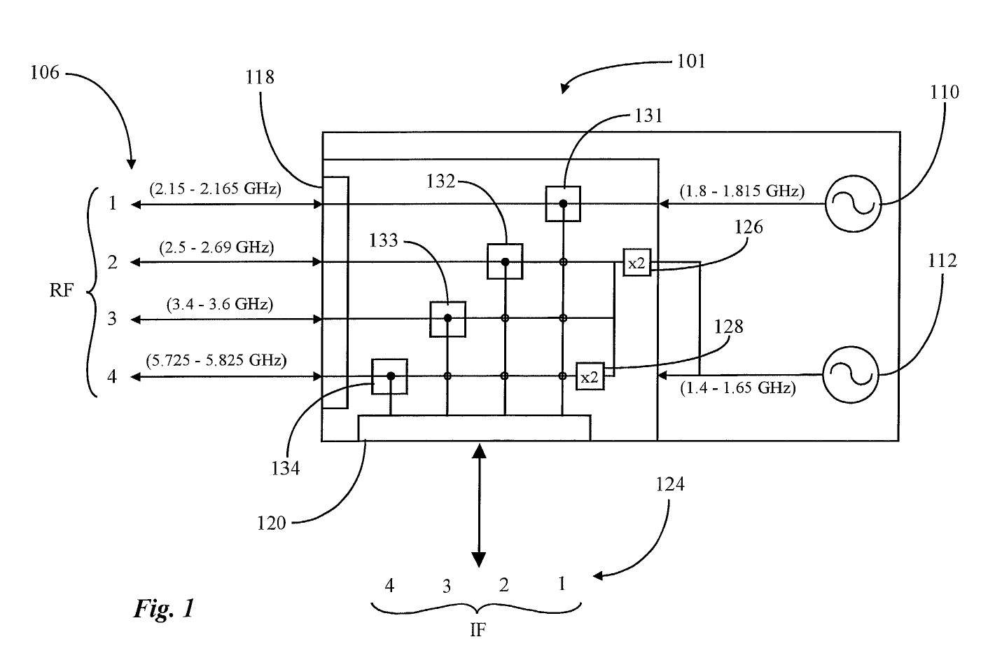

FIG. 1 illustrates a system for broadband radio frequency up-conversion and down-conversion according to an embodiment of the present invention. Device 101 is an example of a part of a transmit and receive system in a broadband application, incorporating a solution that provides a means for reducing the cost and complexity of design of an integrated device used for up-conversion and down-conversion of frequency bands, while achieving the very wide tuning range and phase noise control required for wide band wireless applications.

Device 101 in this example utilizes new and novel practices for providing the local oscillator signals required for synthesizing four separate signal bands, and achieves the required frequencies using fewer than four voltage controlled oscillators (VCOs). To accomplish the desired result, device 101 in this embodiment achieves the wide frequency range utilizing a system based on frequency doubling and quadrupling, coupled with practice of upper or lower sideband selection principles. Device 101 is the host device (mixer) for a smart local oscillator architecture in this example, and is an inexpensive, easy to manufacture integrated mixer device that is not silicon-area intensive and comprises circuitry less complex than would be conventionally required to cover the illustrated wide range of frequencies.

In a typical broadband application, as is true in this example, the frequency range of signals to be received and transmitted may range from 2.15 GHz to 5.825 GHz, and in this example are split into four separate smaller bands, each with a smaller frequency range. In this example the broadband frequency range for transmit or receive by device 101 comprises four separate frequency bands 106, band 1 having a frequency range of 2.15 GHz to 2.165 GHz, band 2 ranging from 2.5 GHz to 2.69 GHz, band 3 ranging from 3.4 GHz to 3.6 GHz, and band 4 from 5.725 GHz to 5.825 GHz. The variations of the separate smaller frequency bands in this example are common in a typical broadband application, however the frequency range and number of bands may vary widely in other applications where the present invention may be used.

Utilizing conventional methods to transmit and receive signals over the entire frequency range of 2.15 GHz and 5.825 GHz, while achieving acceptable phase noise, a mixer for up- and down-conversion of each of the four bands must be served by a separate VCO for each band in order to cover all of the frequency bands, since none of the frequency bands can be combined due to the limited 16% tuning range of on-chip VCOs available in current technology.

Device 101 is a novel mixer in an embodiment of the present invention, providing down-conversion and up-conversion of the signals in the four frequency bands that must be served in this example. Upon down-conversion of incoming signals in frequencies represented in bands 106, the signals must be presented at a fixed lower frequency, or intermediate frequency, to modulation/demodulation circuitry not shown. One with skill in the art will recognize that only one of the four receive/transmit bands is served at any one time period. The means of assigning time periods among the four bands shown is not pertinent to the present invention, and such means are well known in the art, so no further description of that aspect is provided herein.

In this example the intermediate frequency is 350 MHz, determined to be a workable frequency for modulation and demodulation in transmit and receive systems used in broadband wireless applications. Intermediate frequency signal 124 at 350 MHz, which in any one of four appropriate time periods carries the modulated signal for a particular one of bands 1 through 4, interfaces with device 101 via interface 120. The diagram of FIG. 1 illustrates both the up-conversion (from interface 120 to interface 118) and down-conversion (from interface 118 to interface 120) of signals in transmit and receive mode respectively. For transmit and receive of signals on the various broadband frequency bands 106 interface 118 and IF interface 120 provide connections to circuitry within chip device 101 for up-conversion and down-conversion of both incoming and outgoing signals. Again, as is well-known in the art, timing systems provide for band selection and up- or down-conversion selection.

The up-conversion and down-conversion for outgoing and incoming signals is accomplished by circuits providing an electronic interface between each of the frequency bands 106, and the IF signals 124. As shown, a circuit 131 is provided for band 1 of the broadband spectrum, and circuits 132, 133, and 134 are for bands 2, 3, and 4 respectively. To achieve conversion of the separate bands in the broadband spectrum in this example to the intermediate frequency of 350 MHz, local oscillator (LO) signals in this embodiment are generated by only two on-chip VCOs, VCO 110 and VCO 112, each having the limited tuning range and voltage capacitance available from on-chip varactors of current technology. LO signals from VCOs 110 and 112 are provided via electronic connection to circuits 131-134, and in some cases by doubling or quadrupling to circuitry within device 101 and enable conversion to or from the intermediate frequency of 350 MHz.

In the example presented in FIG. 1, a first band 106 at interface 118 has a frequency range of 2.15 GHz to 2.165 GHz. For down-conversion, in order to translate the frequency of band 1 to the intermediate frequency of 350 MHz, a frequency range of a local oscillator may be provided in either of two frequency ranges. One may use either of upper or lower side-band selection for the down-conversion, therefore an LO frequency range of either [1.8 to 1.815], and upper side-band selection, or [2.5 to 2.512], and lower side-band selection may be used. In the present example the frequency produced by VCO 110 is 1.8 GHz to 1.815 GHz, utilizing upper side-band selection to cover the frequency range of 2.15 to 2.165 GHz.

As previously mentioned, in order to receive and transmit all of the signals within the combined frequency range of bands 106, a typical system of conventional art requires four separate on-chip VCOs (or an expensive off-chip veractor), each with a limited tuning range of 16% of the other frequency bands, thereby preventing the combination of any frequency bands for implementation by any single VCO. This prior-art solution, while more compact and less expensive than other methods utilizing off-chip components as described, can be very silicon-area intensive and complex in design, reducing reliability and increasing cost.

The present invention however, utilizes VCO 112 in this embodiment as a second VCO which serves all of the remaining bands 2, 3, and 4 so that all of the signals within the entire frequency range of bands 106 can be received and transmitted by system 101. The very large tuning range required for the implementation of the remaining incoming bands 2, 3, and 4 of bands 106 is achieved in this embodiment by frequency doubling techniques as are shown in this example, and by upper or lower sideband selection principles applied within circuits of device 101, described later in greater detail.

VCO 112 produces LO signals in this example in a range of frequencies somewhat larger than that of VCO 110, but still within the limited tuning range necessary for phase noise requirements, as described earlier. The frequency range of signals produced by VCO 112 in this case can be either 1.4 GHz to 1.65 GHz, or 2.8 GHz to 3.3 GHz, both ranges within the 16% tuning range limitation. The frequency range selection depends upon which range provides optimal phase noise for the LO signal at the required frequency. The LO frequency for VCO 112 is determined empirically by considering the frequency ranges of bands 2, 3, and 4 at the transmit and receive interface 118, the IF of 350 MHz, the upper and lower side-band principles, and the possibility of frequency doubling circuitry. Given these considerations the inventor has found that one may determine all of the possible LO candidate frequencies for the active signals (two for each active frequency band), and then determine if any of the candidate frequencies, by doubling or redoubling, may be used in place of other candidate LO frequencies, thereby eliminating the need for separate and distinct on-chip VCOs for those frequency ranges.

In the present example, if VCO 112 is implemented as [2.8 GHz-3.3 GHz], one may serve band 2 by lower side-band selection, and band 3 by upper side-band selection. Consider the following equations, for example:

Band 2:[2.5 GHZ-2.69 GHz]=[2.8 GHZ-3.3 GHz]−350 MHz(LSB)

Band 3:[3.4 GHz-3.6 GHz]=[2.8 GHz-3.3 GHz]+350 MHz(USB)

Further, by doubling the frequency of VCO 112, which requires relatively simple, inexpensive and reliable circuitry, one may cover band four, using lower side-band selection. Consider:

Band 4:[5.725 GHz-5.825 GHz]={[2.8 GHz-3.3 GHz]*2}−350 MHz

The implementation for band 4 uses LSB selection.

In a preferred implementation, as indicated in FIG. 1, VCO 112 is implemented as [1.4 GHz -1.65 GHz] and this input is doubled once, then used with LSB selection to serve band 2 and USB selection to serve band 3. The doubled frequency is doubled again, and used with LSB selection to serve band 4.

Again, utilizing the frequency doubling techniques described for LO signals from on-chip VCOs 110 and 112, coupled with upper or lower sideband selection principles applied in mixer circuits 131, 132, 133, and 134, the down-conversion of the incoming bands in the broadband spectrum to the intermediate frequency, or up-conversion of IF signals to any one of the necessary transmit frequencies can be accomplished. Electronic connection to IF signal 124 is made for all incoming frequency bands 106 and their associated mixer circuits by circuitry within mixer 107 between IF interface 120 and interface 118.

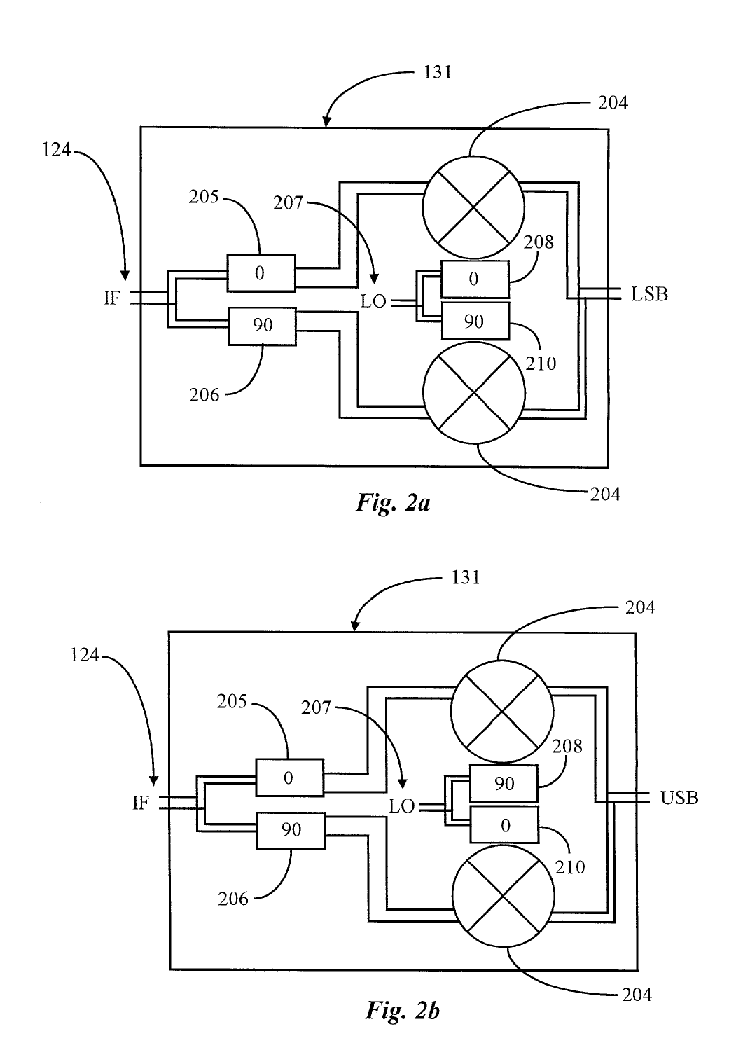

FIG. 2a illustrates lower sideband selection in a mixer circuit used for up-conversion of IF signals according to an embodiment of the present invention. Mixer circuit 131 of FIG. 1 is used in this example to more clearly present the circuitry and method utilized within device 101 in the preferred embodiment for the sideband selection process that is used for implementation of band 1 of bands 106 in a broadband application. Mixer circuit 131 utilizes well-known sideband selection circuitry as is represented in this simple diagram for up-conversion of the signals of the intermediate frequency band 1 of IF signal 124 of FIG. 1, for transmit on broadband frequency band 1 within the higher frequency range of 2.15 GHz to 2.165 GHz. The information-bearing intermediate frequency, represented in this example as IF 124, at the intermediate frequency of 350 MHz, will be up-converted for band 1 using the LO signal to the generate the RF signal at a frequency band of 2.15 GHz to 2.165 GHz for transmission as band 1 at interface 118.

IF signal 124, in this example at 350 MHz, passes into circuitry of mixer 131 and into phase blocks having the purpose of implementing phase shifts upon the intermediate frequency waveform. Block 205 allows a direct pass-through of the IF signal. A 90 degree phase shift is imposed on the IF signal by block 206. The resulting in-phase and quadrature components of the intermediate frequency then pass to mixers 204 as shown. Mixers 204 are up-conversion mixers used to heterodyne both components of the intermediate frequency with components of the local oscillator (LO) frequency. A first mixer 204 is used in this example for mixing the in-phase component of the intermediate frequency with the LO signal also unshifted, while a second mixer 204 is used for mixing the quadrature component of the LO signal with the quadrature component of the IF signal. Block 208 passes the LO signal, while block 210 shifts the phase of the LO signal by 90 degrees. From mixers 204 the two signals are brought together (summed) to produce the LSB-selected signal, which, in this case will be the 2.15 to 2.165 transmit frequency for band 1 at interface 118. The sideband selection process in this example uses sinusoidal frequency multiplication and addition techniques, well-known in the art, resulting in lower and upper sidebands, to determine whether to select either the lower or upper sideband for transmission of the RF signal. In the example shown, LO signal 207 is generated by the VCO at a frequency band of 1.8 GHz to 1.815 GHz, which is a frequency band less than that of the transmit frequency of 2.15 GHz by a difference of exactly 350 MHz, or the intermediate frequency.

FIG. 2b illustrates upper sideband selection in a mixer circuit used for up-conversion of an IF signal for transmission according to an embodiment of the present invention. For upper sideband selection, the process is similar to that described for FIG. 2a, in that the in-phase and quadrature components of IF signal are passed on to mixers 204 for up-conversion prior to transmit, where they are mixed through sinusoidal frequency multiplication with components of the local signal 207, and then combined again for transmission. In this case however, the in-phase component of IF signal 124 is mixed by a first mixer 204 with the quadrature component of LO signal 207, and the quadrature component of IF signal 124 is mixed by a second mixer 204 with the in-phase component of LO signal 207. The resulting signals are added, as before, producing a new signal frequency by upper sideband selection. As an example of the use of the circuitry of FIG. 2b, consider the previously described up-conversion of band 3 at interface 120 to transmit as band 3 at interface 118. Referring now to FIG. 1 again, an LO signal from VCO 112, at a band of 1.4 GHz to 1.65 GHz is doubled by circuitry 126 and provided to circuitry 133 as the LO signal (FIG. 2b). Upper sideband selection produces an output according to the relationship previously shown and reproduced here:

Band 3:[3.4 GHz-3.6 GHz]=[2.8 GHz-3.3 GHz]+350 MHz(USB)

The descriptions provided for FIG. 2a and 2b pertain to frequency up-conversion of the intermediate frequency to the desired RF frequency in a transmit mode. A system similar to that for transmit is also employed for receiving and down-converting RF frequency bands into the intermediate frequency also utilizing the described sinusoidal multiplication of the in-phase and quadrature components of the RF and local frequencies, and upper or lower sideband selection circuitry. Following the diagrams of FIGS. 2a and 2b, in such a system, for upper sideband down-conversion, the incoming RF frequencies are passed directly to the mixers 204 where they are heterodyned with in-phase and quadrature components of the local oscillator signal in separate paths. The resulting signal from mixing the incoming signal directly with the LO signal is then shifted 90 degrees and summed with the signal from the upper mixer 204 that was mixed with the 90-degree phase-shifted component of the LO signal. The result is the LSB IF signal desired.

It will be apparent to one with ordinary skill in the art that the circuitry components of FIGS. 2a and 2b, implemented in device 101 as circuits 131-134, could be switched to provide either up-conversion or down-conversion as needed. Moreover, the outputs of VCOs 110 and 112 may be switched to frequency doubling circuitry as needed to produce multiplied frequencies.

In preferred applications a dedicated chip 101 for up- or down-conversion, or one each for up-conversion and down-conversion, having fewer VCOs implemented on the chip(s) than the number of specific bands within a broad-band spectrum, is be provided. In some other embodiments programmability may be provided for switching components on the chip to provide different connectability of components to provide a more flexible device. The dedicated case is preferred at the present time because of the added complexity and therefore cost of switching and programmability to provide the necessary variability.

In practice, following the teaching of the present invention, by utilizing frequency multiplication techniques and upper or lower sideband selection principles, given any reasonable number of bands within the frequency range of a broadband spectrum, in most cases a fewer number of local oscillator frequencies may be used to cover all of the bands in the broadband spectrum than the number of bands, thereby reducing the cost and complexity of the silicon device used for the generation of the local oscillator signals. It will also be apparent to the skilled artisan that the embodiment described for the present invention can be used for up-conversion or down-conversion of broadband signals in frequency bands differing in ranging and number from those described herein, and may be practiced in a variety of systems or appliances used in the propagation and reception of signals in a broadband fixed-wireless access-application, without departing from the scope and spirit of the invention. It will also be apparent that the embodiments described are exemplary only, and the necessary circuitry and connectivity may be provided in a number of ways without departing from the spirit and scope of the invention. For all of these reasons and more the invention should be afforded the broadest possible scope based on the claims that follow.

What is claimed is:

1. A conversion integrated circuit (IC) for RF signals, comprising;
a first interface for transmitting or receiving a first number of distinct RF frequency bands in a broadband spectrum,
a plurality of circuit elements coupled to the first interface, one for each of the frequency bands, for up-conversion or down-conversion of the frequency bands to and from an intermediate frequency (IF);
a second interface coupled to said circuit elements for receiving and transmitting at the intermediate frequency (IF); and
a second number of on-chip voltage-controlled oscillators (VCOs) coupled to the circuit elements for generating local-oscillator (LO) signals to the circuit elements for conversion between the IF frequency and the receive or transmit frequency for each band;
characterized in that the second number is smaller than the first number.

2. The IC of claim 1 wherein one of the on-chip VCOs, through alternative sideband selection, provides the LO frequency for two or more of the RF frequency bands in the broadband spectrum.

3. The IC of claim 1 further comprising frequency doubling circuitry coupled to one of the VCOs, such that the coupled one of the VCOs provides a different frequency to each of two of the sideband selection circuit elements.

4. The IC of claim 1 further comprising frequency doubling circuitry coupled to one of the VCOs, such that the VCO, through frequency doubling and/or redoubling, and through alternative sideband selection, provides the LO frequency for up-conversion or down-conversion of three or more of the RF frequency bands in the broadband spectrum.

5. The IC of claim 1 dedicated to down-conversion of the RF frequency bands.

6. The IC of claim 1 dedicated to up-conversion of the RF frequency bands.

7. The IC of claim 1 having circuit elements for both up-conversion and down-conversion.

8. A broadband receiving/transmitting system, comprising:
an antenna for receiving or transmitting RF signals in a broadband spectrum including a first number of signal bands;
a conversion integrated circuit (IC) coupled to the first number of signal bands by a first interface of the IC; and
modulation circuitry coupled to the IC by a second interface of the IC for receiving or transmitting each of the bands at a common intermediate frequency (IF);
characterized in that the conversion IC comprises a plurality of circuit elements coupled to the first interface, one for each of the frequency bands, for up-conversion or down-conversion of the frequency bands to and from an intermediate frequency (IF), and a second number of on-chip voltage-controlled oscillators (VCOs) coupled to the circuit elements for generating local-oscillator (LO) signals to the circuit elements for conversion between the IF frequency and the receive or transmit frequency for each band, the second number less than the first number.

9. The system of claim 8 wherein one of the on-chip VCOs, through alternative sideband selection, provides the LO frequency for two or more of the RF frequency bands in the broadband spectrum.

10. The system of claim 8 further comprising frequency doubling circuitry coupled to one of the VCOs, such that the VCO provides a different frequency to each of two of the sideband selection circuit elements.

11. The system of claim 8 further comprising frequency doubling circuitry coupled to one of the VCOs, such that the VCO, through frequency doubling and/or redoubling, and through alternative sideband selection, provides the LO frequency for up-conversion or down-conversion for three or more of the RF frequency bands.

12. The system of claim 8 dedicated to down-conversion of the RF frequency bands.

13. The system of claim 8 dedicated to up-conversion of the RF frequency bands.

14. The system of claim 8 having circuit elements for both up-conversion and down-conversion.

15. A method for providing local oscillator (LO) signals to a first number of sideband-selection circuit elements in up-conversion or down-conversion circuitry, for a broadband spectrum including the first number of frequency bands, comprising the steps of:
(a) providing a second number of on-chip voltage-controlled oscillators (VCOs), the second number fewer than the first number; and
(b) serving all of the circuit elements with appropriate LO frequencies by one or both of alternative sideband selection and frequency doubling techniques.

16. The method of claim 15 wherein, in step (b), one of the on-chip VCOs, through alternative sideband selection, provides the LO frequency for two or more of the RF frequency bands in the broadband spectrum.

17. The method of claim 15 wherein frequency doubling circuitry coupled to one of the VCOs provides a different frequency to each of two of the sideband selection circuit elements, the provided VCO frequency being doubled for one of the circuit elements, and doubled again for another.

18. The method of claim 15 wherein frequency doubling circuitry coupled to one of the VCOs, such that the VCO, through frequency doubling and/or redoubling, and through alternative sideband selection, provides the LO frequency for up-conversion or down-conversion to three or more of the RF frequency bands.

19. The method of claim 15 dedicated to down-conversion of the RF frequency bands.

20. The method of claim 15 dedicated to up-conversion of the RF frequency bands.

21. The method of claim 15 enabled for both up-conversion and down-conversion.
